(19) United States
(12) Patent Application Publication
(10) Pub. No.: US 2003/0149978 A1
(43) Pub. Date: Aug. 7, 2003

(54) System and method for using a personal digital assistant as an electronic program guide

(76) Inventor: Bruce Plotnick, Jamison, PA (US)

Correspondence Address: BROWN, RAYSMAN, MILLSTEIN, FELDER & STEINER LLP, 900 THIRD AVENUE, NEW YORK, NY, 10022, US

(21) Appl. No.: 10/072,553

(22) Filed: Feb. 7, 2002

(51) Int. Cl. G06F 3/00; H04N 5/445; G06F 13/00; H04N 7/173; H04N 7/00; H04N 11/00

(52) U.S. Cl. 725/39; 348/552; 725/47; 725/54; 725/133

(57) ABSTRACT

The present invention comprises a system and method for using a personal digital assistant to browse and select program listings. The method of the present invention involves browsing one or more program listings to select a given program listing. The program listings are presented on the personal digital assistant through the use of a local electronic program guide. Where a program corresponding to the given program listing is not being aired when selected, the given program is marked for a reminder in the local electronic program guide. The reminder in the local electronic program guide is synchronized with a remote electronic program guide running on a remote device.

### RELATED APPLICATIONS

This application is related to the following commonly owned provisional and utility applications, which are hereby incorporated by reference in their entirety:

application Ser. No. 60/______, entitled “SYSTEM AND METHOD FOR DIGITAL TV NAVIGATOR AND EPG”, attorney docket no. 4665/4PROV, said application filed on Dec. 13, 2001;

application Ser. No. 09/______, entitled “SYSTEM AND METHOD FOR PROVIDING ACCESS TO EPG FEATURES FROM WITHIN BROADCAST ADVERTISEMENTS”, attorney docket no. 4665/5, said application filed on Dec. 17, 2001;

application Ser. No. 09/______, entitled “METADATA STRUCTURE FOR PROVIDING ACCESS TO EPG FEATURES FROM WITHIN BROADCAST ADVERTISEMENTS”, attorney docket no. 4665/6, said application filed on Dec. 17, 2001;

application Ser. No. 09/______, entitled “SYSTEM AND METHOD FOR DISPLAYING EDITORIAL CONTENT THROUGH TELEVISION NAVIGATION CONTROLS AND ELECTRONIC PROGRAM GUIDES”, attorney docket no. 4665/7, said application filed on Dec. 17, 2001; and

application Ser. No. 09/______, entitled “SYSTEM AND METHOD FOR AUTOMATICALLY FLAGGING A CHANNEL AS A FAVORITE CHANNEL”, attorney docket no. 4665/8, said application filed on Dec. 17, 2001.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The invention disclosed herein relates generally to electronic program guides. More particularly, the present invention relates to using a handheld device, such as a PDA, as a platform for an electronic or interactive program guide, and for using the information to remotely control a television, set top terminal, video recorder or other audio/video peripheral.

Electronic or interactive program guides (“EPG” or “IPG”) are widely used to browse television listings presented on a display device. Program guides also provide functionality to select programming, set reminders, or select programs for current or future recording. Typically, electronic program guide software is stored on and executed by a set top terminal device, which is connected to both a display device and a distribution network, e.g., cable or satellite programming distribution system. Using the software, the set top terminal accesses program guide data distributed over the network, which is presented to the viewer on the television or other display device.

Over the past several years, a new class of mobile computing device has emerged, typically referred to as a personal digital assistant or PDA. One of the hallmarks of the PDA is its small form factor, typically capable of being held in the palm of one hand and interacted with by means of a stylus or other type of non-keyboard input device. A PDA may also utilize a virtual keyboard or reduced size physical keyboard in order to receive input. One of the main functions of a PDA is executing personal information management (PIM) software, which includes calendars, appointment schedulers, phonebooks, and to-do lists. A modem PDA is also capable of running applications such as word processors, spreadsheets, and databases. These devices may further be provided with one or more types of network connections for communicating with personal computers, paging services, web server, or other wired and wireless communication services.

With advances in wireless and handheld technology, portable computing devices and PDAs are capable of remotely connecting to personal computers, data servers, and other types of networked data and software services. Through connections to these servers and services, portable and handheld computing devices are now able to retrieve large databases for local storage and access. These databases may be used to store television program listings in a readily accessible format, such as HTML or XML pages.

There is thus a need for a system and method where a handheld computing device is used as a platform for an electronic or interactive program guide for accessing television program listings. There is a further need for a system and method where the handheld computing device uses the electronic or interactive program guide to program or remotely control a television, set top terminal, video recorder or other audio/video peripheral.

### BRIEF SUMMARY OF THE INVENTION

The instant invention comprises a system and method for using a personal digital assistant to browse and select program listings. The method of the present invention comprises browsing one or more program listings to select a given program listing. The program listings are presented on the personal digital assistant through the use of a local electronic program guide. Where a program corresponding to the given program listing is not being aired when selected, the given program is marked for a reminder in the local electronic program guide. The reminder in the local electronic program guide is synchronized with a remote electronic program guide running on a remote device.

The method of the present invention comprises tuning the program on a display device connected to a distribution network where the program corresponding to the given program listing is being aired when selected. The invention also contemplates marking the given program listing in the local electronic program guide with a video record mark, the mark indicating that the program associated with the given program listing is to be recorded at its air time. The video record mark is synchronized in the local program guide with the remote electronic program guide running on a remote device.

Another aspect of the present method comprises marking the given program listing in the local electronic program guide with a video record mark, the mark indicating that the program associated with the given program listing is to be recorded at its air time. One or more parameters associated with the given program listing are copied to a recording device to instruct the recording device to record the program associated with the given program listing. The step of copying one or more parameters may comprise copying a channel the program is airing on, a title of the program, a start time of the program, an end time of the program, and a description of the program.

The personal digital assistant may also be supplied with personal information management software, including calendar software. The given program selected by the user may be marked for a reminder in a calendar application on the personal digital assistant. An alert may also be issued when the given program is scheduled to air.

The present invention also comprises a system for using a personal digital assistant to browse and select program listings. The system comprises a program listing server to distribute program guide data over a distribution network and a mobile computing device. The mobile computing device stores a local electronic program guide and is operative to receive the program guide data, which is presented by the local electronic program guide, the local program guide further operative to receive input to set a recording mark or a future program reminder. A remote electronic program guide is also provided, the remote electronic program guide operative to synchronize the recording mark or future program reminder with the local program guide.

According to one embodiment of the invention, the mobile computing device comprises a personal digital assistant, which may comprise calendar software. The future program reminder, which may comprise a broadcast channel, a program title, a start time and an end time, is recorded in the calendar software. The calendar software may also issue an alert when the start time is arrived at. Furthermore, the personal digital assistant is operative to synchronize the recording mark with a recording device or the remote electronic program guide, which may be resident on a set top terminal.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram presenting a configuration of hardware and software components for using a personal digital assistant as an electronic program guide according to one embodiment of the present invention;

FIG. 2 is a flow diagram presenting a method for using a personal digital assistant as an electronic program guide according to one embodiment of the present invention; and

FIG. 3 is a flow diagram presenting another method for using a personal digital assistant as an electronic program guide according to one embodiment of the present invention.

### DETAILED DESCRIPTION OF THE PREFERRED EMBODIMENTS

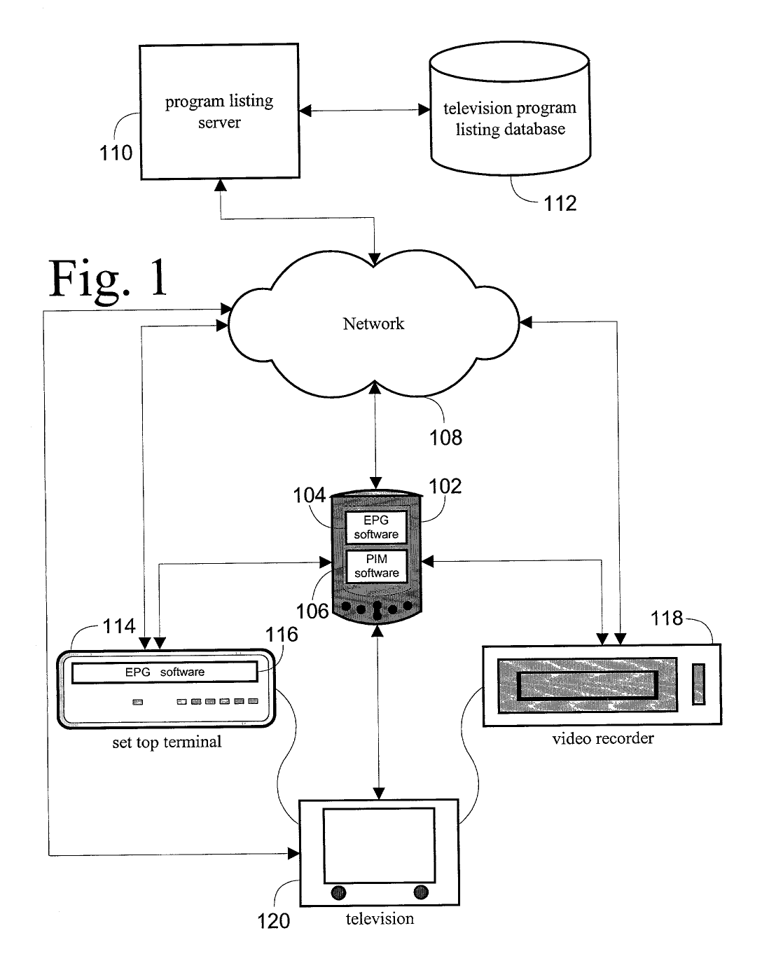

With reference to FIGS. 1 through 3, embodiments of the instant invention are presented. Turning to FIG. 1, a system for presenting, distributing and navigating programming content is presented. A distribution network 108 is used to distribute digital and/or analog audio and video data to a subscribing customers' set top terminal 114 for presentation on a television 120 or other display device. According to some embodiments, the distribution network 108 comprises a coaxial infrastructure, a fiber infrastructure, a hybrid fiber-coax infrastructure, a wireless infrastructure, or a combination of these and other delivery technologies well known to those skilled in the art.

Programming and guide data is transported across the distribution network 108 to a subscriber's set top terminal 114. Exemplary set top terminals include the DCT1000 and DCT2000 manufactured by Motorola, and the Explorer 2000, 3100, 6000 and 8000 manufactured by Scientific Atlanta, or any other set top terminal or receiver as are well known to those skilled in the art. According to an alternative embodiment of the invention, a programming distribution network is used to distribute programming content to subscriber households and another network is used to distribute associated programming guide data.

A television program listing database 112 maintains television program listing data for retrieval and distribution by a program listing server 110. The television program listing database may comprise any type of data store including, but not limited to, a relational database, an object-oriented database, or a hybrid relational-object database. Alternatively, the database 112 may comprise a filesystem structure organized so as to facilitate simplified retrieval of desired television program listing data, e.g., organizing program listings by date, which a separate directory on the filesystem for each date. The database 112 may even comprise a flat-file, tab-delimited, or similar flat data structure. Furthermore, the television program listing database may only act as a mechanism for organizing the television program listing content, which may reside on a the same or another local or remote storage device. Preferably, the television program listing content comprises pages of HTML or XML program data that is capable of being rendered using web browser software and other applications well know to those skilled in the art.

A network connection is provided between the television program listing database 112 and the program listing server 100. The network connection between the two may be a local or wide area connection distinct from the distribution network 108 or may be the same network 108. The program listing server 110 is operative to receive requests for television program listings from electronic program guides 106 and 116 and return program listing data responsive to the request. According to one embodiment of the invention, the program listing server 110 queries the television program listing database 112 to retrieve raw program listing content, which is formatted at the program listing server 110 for distribution to the requesting EPG 106 and 114 over a network 108. Alternatively, the program listing server 110 queries the television program listing database 112 to retrieve formatted program listing content for distribution to the requesting EPG 106 and 114 over a network, e.g., the distribution network 108. In yet another embodiment, the program listing server 110 distributes raw program listing content to the requesting EPG 106 and 114, where it is formatted for presentation to the user.

A personal digital assistant 102 is provided with access to the distribution network 108. Access may be provided over a wired or wireless connection to the Internet whereby the personal digital assistant communicates with the program listing server 110 to retrieve program guide data. Alternatively, communication may be initiated with the program listing server over the distribution network 108 via a gateway (not pictured), e.g., through the use of a cable modem. The personal digital assistant may be in two-way communication with the program listing server 110 whereby selections made at the remote EPG software 116 are propagated over the distribution network 108 to the program listing server 110 and back to the personal digital assistant 102. In this manner, the personal digital assistant may receive data from the set top terminal 114 and vice versa. The distribution network may distribute program content and guide data directly to the set top terminal where guide data is separated from program content and utilized by the remote EPG software 116 for presentation on a display device, e.g., television 120. Likewise, a similar distribution scheme may be used to distribute data directly to a video recorder 118 or television 120, provided the appropriate software is present, e.g., a cable ready television accompanied by EPG software 116.

The personal digital assistant 102 may be a Palm OS® or Microsoft PocketPC® digital assistant. For example, the personal digital assistant may be an iPaq® 3860 produced by Compaq Computer Corp. In accordance with embodiments of the invention, the personal digital assistant 102 may comprise any type of portable or mobile computing device. The personal digital assistant 102 comprises local persistent storage (not pictured) that is operative to store applications and data, including personal information management (PIM) software 104 and electronic program guide (EPG) software 106.

The PIM software 104, typically stored and executed on the personal digital assistant, is used to maintain and track a user's personal information. Application programs usually falling within the scope of PIM software 104 include, but are not limited to, calendars, address books, to-do lists, and similar applications that may be used to maintain personal data. Many modem personal digital assistants provide a graphical interface to the applications and data stored therein. Using a stylus or other input device, the user is able to graphically interact with the PIM software 104 in order to add, delete and update their personal data.

In addition to PIM software 104, the personal digital assistant is 102 is also provided with electronic program guide (EPG) software 106. The EPG software 106 is used to present program listings received from the program listing server 110 to the user. According to one embodiment, the user is provided with controls to instruct the EPG software 106 to present a programming lineup from to one of several distribution networks. Using controls presented by both the personal digital assistant 102 and EPG software 106, the user is capable of browsing program listings from the present time through the near future. The amount of program data made available may be a function of the available memory on the personal digital assistant 102, may be set to a limit defined by the user, or may be set to a limit defined by developer of the EPG software 106.

In addition to browsing program listings, the EPG software 106 may be used to program and control a variety of audio/video components 114, 118, and 120. Using the EPG software 106 to browse available program listings, an input device may be used to select one or more specific programs for future viewing, thereby instructing the EPG software 106 to mark the program as such. The future viewing reminder may be set so as to generate an alert on the personal digital assistant 102 at the program's air time, which may be an audio or visual alert. Alternatively, as is explained in greater detail herein, the reminder that is set by the user may be used to program a video recording device 118 to record the selected program.

The user may use the PDA's electronic program guide software 106 to directly tune a television 120, typically through the use of coded infrared signals. A plurality of encoding schemes are preferably maintained at the PDA 102 in order to ensure the proper encoding scheme is used, with additional codes retrievable from a server over a network. According to one embodiment, a lookup table is employed that correlates each encoding scheme with an identifier. By inputting an identifier for the encoding scheme that matches the equipment to be controlled, the PDA may transmit coded infrared signals to wirelessly transmit commands to an audio/video device. Once configured, if required, instructions are transmitted from the PDA to either the set top terminal 114 or the television 120, depending on the specific configuration, to tune to a desired channel of programming. The tuning is preferably conducted through the use of encoded infrared signals transmitted from the PDA 102 for receipt over an infrared interface (not pictured) on the television 120 or set top terminal 114, although other communication schemes are contemplated by the invention.

The local electronic program guide software 106 running on the PDA 102 is capable of synchronizing data with the remote electronic program guide 116 executing on the set top terminal 114. Communication is initiated between the PDA 102 and the set top terminal 114 whereby markers set by the user in the PDA's electronic program guide software 106 to remind the user about future programs are transmitted to the set top terminal's electronic program guide software 116. Likewise, recording and future program markers set by the user at the set top terminal may be transmitted by any of the communication schemes described herein so as to synchronize markers on both devices. According to one embodiment, the future program reminders are transmitted between the two devices 102 and 114 over an infrared link (not pictured). Alternatively, the PDA 102 may be interfaced to a common network 108, such as the Internet, over which the programming reminders are synchronized between the software 106 and 116 running on the two devices 102 and 114 respectively. The EPG software 102 may also synchronize programs marked for recording with a video recorder 118 so that these marked programs are automatically recorded.

In addition to the aforementioned functionality, software interconnections are provided between the PIM software 104 and the EPG software 106 running on the PDA 102. Using an input device in conjunction with the EPG software 106, a user selects program listings identified as being broadcast at a future time. Each selected program generates, among several possible options, a reminder that alerts the user when the selected program is about to commence. A message is passed from the EPG software 106 to the PIM software 104 indicating that a program reminder has been set in addition to parameters regarding the specific program. Exemplary parameters passed to the PIM software 104 include, but are not limited to, the start and end time of the program, the title of the program, the channel on which the program will be broadcast, and any other miscellaneous program information. The PIM software 104 receives the program information and places the information in the user's calendar at the indicated date and time. In this manner, the user may be alerted via the PDA 102 when a marked program is about to begin, in addition to being able to view the playtimes of marked programs directly in the calendar provided by the PIM software 104 along side other scheduled appointments.

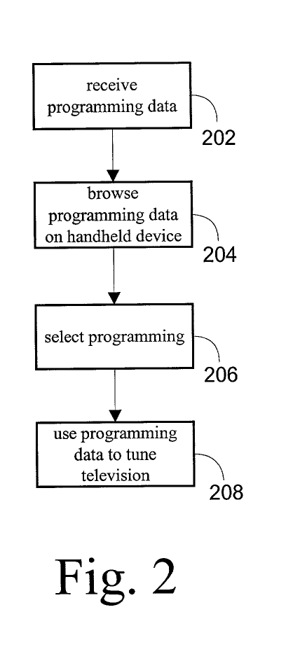

Turning now to FIG. 2, a high level method of operating the system illustrated is presented. A personal digital assistant running electronic program guide software and in communication with a program listing server via a network is operative to receive data regarding programming broadcast on a distribution network, step 202. The programming data may be in any form useable by the electronic program guide software including, but not limited to, HTML data pages, XML data pages, tab delimited data pages, etc. According one embodiment, the EPG uses the data to construct pages of programming for navigation by the user. Alternatively, the device serving the programming data to the EPG running on the PDA creates the pages of programming, which are displayed on the PDA's display device for navigation by the user.

The personal digital assistant receives and displays the data for navigation by the user, step 204. Regardless of the method of transmission and generation, the user may navigate the programming content through the normal use of the PDA input method, e.g., tapping selections and navigation controls with a stylus. One embodiment of the programming content comprises an irregular grid of cells displayed as a matrix of channels versus time whereby each cell represents the programming on a given channel at a given time. According to other embodiments of the invention, the programming content is presented as shown in the related applications that have previously been incorporated by reference. The user browses programming content, step 204, by manipulating the pages of programming content, e.g., displacing the matrix of cells to browse programming available on the channel lineup at a given time or programming available on a channel at a given time. When a desired program is arrived at, it is selected, step 206.

The selection by the user of a desired program is used to tune a television or similar tunable display device, step 208. The step of tuning the television may encompass one or more of several tuning actions. For example, the user may select a program that is currently playing on an available channel, step 206. According to this scenario, a signal is sent from the PDA to either the television or set top terminal, depending on the particular configuration of the user's video equipment and device used, to tune the selected program being distributed over the distribution network. Alternatively, a user may also select to watch programming that is being aired at a later time, step 206. The programming data selected by the user is transmitted from the PDA to the television or set top terminal, where a reminder is set in the EPG software that the program has been selected for viewing at its air time. The reminder may likewise be recorded in the EPG running on the PDA and synchronized with the EPG running on the set top terminal or television when communication between the two is established.

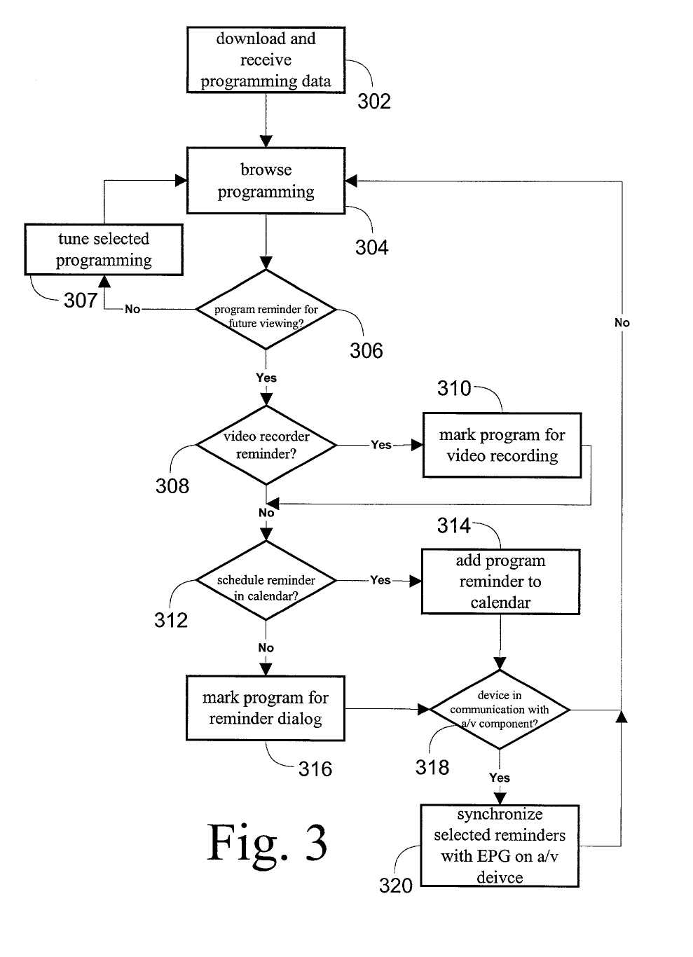

Another method of operating the hardware and software components illustrated in FIG. 1 is presented in FIG. 3. Programming data is downloaded to and received by a personal digital assistant, step 302. The data transmission may be performed using wireless or other data transmission techniques well known to those skilled in the art. Alternatively, the PDA may be provided with a wired interface to the programming data, e.g., a modem communicating over the public switched telephone network. Regardless of the method of transmission, the programming data is received by the personal digital assistant made available to the user through local EPG software, step 302.

The received programming data is browsed by the user through the use of the EPG software, step 304, which presents the programming data in an organized and coherent fashion that is easily navigated by the user. According to one embodiment, the EPG software presents the programming data as a matrix of cells that may be browsed by displacing the matrix along its horizontal or vertical axis. The matrix is preferably organized as channel versus time, with each cell representing a program offered on a particular channel at a particular time. Using an input device, the user browses the programming data presented through the EPG to select a program for current or future viewing, step 304. A check is performed to determine the user has selected a program airing at a later time and therefore requires a program reminder to be set, step 306. Where the user has selected a program currently being aired, the television or display device is tuned to the desired channel, step 307, and control returns to step 304 where the user is free to browse additional programming data.

Where the check resolves to true, e.g., the user has selected a program airing in the future, step 306, the local EPG software checks to determine if the user has selected to record the future airing program, step 308. Where the check resolves to true, step 308, the program is marked in the local EPG running on the PDA for recording. For example, a flag may be set that comprises parameters such as the time and date to begin recording, as well as the channel to record.

Regardless of whether the user selects to record the future airing program, step 308, the local EPG software checks to determine if the user has selected to schedule a reminder in the calendar provided via the PIM software, step 312. Where the check resolves to true, program data for the selected program is passed to the PIM software or other calendar application, step 314. According to one embodiment of the invention, the local EPG software collects the title, program start and end times, program air date, and any other descriptive data included in the set of program data for the selected program. This PIM software receives this data, which is inserted into the calendar on the date and at the start time specified by the program data received from the local EPG software.

If the user does not opt to set a reminder in the PIM software's calendar, step 312, the program is marked for a reminder in the local EPG, step 316. The marker may be a simple flag that is set to indicate that a reminder should be displayed on the display device when the program is to air. Preferably, the EPG software presents the user with several alerts in the minutes leading up to the program air time.

Regardless of whether the user selects to schedule a reminder in the PIM software's calendar, step 312, the local EPG software checks to determine if the PDA is in communication with a remote EPG application, e.g., running on a set top terminal or television, step 318. Alternatively, the PDA may be connected to and in communication with the remote EPG application over a wired connection, e.g., over a computer network. If the PDA is not in communication with a remote EPG application, step 318, the user is free to browse and select additional programming, steps 304, 306 and 307. According to various embodiments, the EPG software periodically checks to determine if the PDA is in communication with a device running the remote EPG, e.g., a set top terminal. Where the PDA is in communication with a remote EPG application, step 318, the reminders recorded on the local EPG are synchronized with the remote EPG software, step 320. Synchronization includes copying all future program reminders and video recording reminders to the remote EPG software. The user is free to browse and select additional programming using the PDA, steps 304, 306 and 307.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. A method for using a personal digital assistant to browse and select program listings, the method comprising:
browsing one or more program listings to select a given program listing, the program listings presented on the personal digital assistant through the use of a local electronic program guide;
where a program corresponding to the given program listing is not being aired when selected, marking the given program for a reminder in the local electronic program guide;
synchronizing the reminder in the local electronic program guide with a remote electronic program guide running on a remote device.

2. The method of claim 1 comprising tuning the program on a display device where the program corresponding to the given program listing is being aired when selected.

3. The method of claim 1 comprising:
marking the given program listing in the local electronic program guide with a video record mark, the mark indicating that the program associated with the given program listing is to be recorded at it's air time; and
synchronizing the video record mark in the local program guide with the remote electronic program guide running on a remote device.

4. The method of claim 1 comprising
marking the given program listing in the local electronic program guide with a video record mark, the mark indicating that the program associated with the given program listing is to be recorded at it's air time; and
copying one or more parameters associated with the given program listing to a recording device to instruct the recording device to record the program associated with the given program listing.

5. The method of claim 4 wherein the step of copying one or more parameters comprises copying a channel the program is airing on, a title of the program, a start time of the program, an end time of the program, and a description of the program.

6. The method of claim 1 comprising marking the given program for a reminder in a calendar application on the personal digital assistant.

7. The method of claim 6 comprising issuing an alert when the given program is scheduled to air.

8. A system for using a personal digital assistant to browse and select program listings, the system comprising:
a program listing server to distribute program guide data over a distribution network;
a mobile computing device storing a local electronic program guide, the mobile computing device operative to receive the program guide data, which is presented by the local electronic program guide, the local program guide further operative to receive input to set a recording mark or a future program reminder; and
a remote electronic program guide operative to synchronize the recording mark or future program reminder set on the local program guide.

9. The system of claim 8 wherein the mobile computing device comprises a personal digital assistant.

10. The system of claim 8 wherein the mobile computing device comprises calendar software.

11. The system of claim 10 wherein the calendar software records the future program reminder.

12. The system of claim 8 wherein the future program reminder comprises a broadcast channel, a program title, a start time and an end time.

13. The system of claim 12 wherein the calendar software issues an alert when the start time is arrived at.

14. The system of claim 8 wherein the personal digital assistant is operative to synchronize the recording mark with a recording device.

15. The system of claim 8 wherein the personal digital assistant is operative to synchronize the recording mark with the remote electronic program guide.

16. The system of claim 8 wherein the remote electronic program guide is resident on a set top terminal.

17. A method for using a personal digital assistant to browse and select program listings, the method comprising:
browsing one or more program listings to select a given program listing, the program listings presented by a remote electronic program guide;
where a program corresponding to the given program listing is not being aired when selected, marking the given program for a reminder in the remote electronic program guide;
synchronizing the reminder in the remote electronic program guide with a local electronic program guide running on a personal digital assistant.

18. The method of claim 17 comprising browsing the program listings presented by a remote electronic program guide stored on a set top terminal.
